(19) United States
(12) Patent Application Publication
(10) Pub. No.: US 2012/0194591 A1
(43) Pub. Date: Aug. 2, 2012

(54) LIQUID EJECTING APPARATUS AND METHOD FOR MANUFACTURING THE SAME

(75) Inventor: Hiroyuki Hagiwara, Matsumoto (JP)

(73) Assignee: SEIKO EPSON CORPORATION, Tokyo (JP)

(21) Appl. No.: 13/365,200

(22) Filed: Feb. 2, 2012

(30) Foreign Application Priority Data
Feb. 2, 2011 (JP) 2011-020584

(51) Int. Cl. B41J 29/38; B23P 17/04

(52) U.S. Cl. 347/14; 29/407.05

(57) ABSTRACT

A storage unit stores temperature correction table in which the temperature T detected by the thermistor is associated with correction information of ink ejection timing, and a printer controller corrects the ink ejection timing of each recording head with reference to the temperature detected by the thermistor and the temperature correction table.

The entire disclosure of Japanese Patent Application No: 2011-020584, filed Feb. 2, 2011 is expressly incorporated by reference herein.

### BACKGROUND

1. Technical Field

The present invention relates to a liquid ejecting apparatus such as an ink jet printer having a plurality of liquid ejecting heads for changing the pressure of a pressure chamber communicating with nozzles and ejecting liquid in the pressure chamber from nozzles, and method for manufacturing the same.

2. Related Art

A liquid ejecting apparatus is an apparatus having a liquid ejecting head for ejecting liquid as a liquid droplet to eject various kinds of liquid from the liquid ejecting head. A representative example of the liquid ejecting apparatus is an image recording apparatus such as an ink jet recording apparatus (printer) which has an ink jet recording head (hereinafter, referred to as a recording head) and ejects ink in a liquid state as an ink droplet from the nozzles of the recording head so as to perform printing. In addition, the liquid ejecting apparatus is recently not limited to the image recording apparatus but also applied to various manufacturing devices such as a display manufacturing apparatus. Moreover, the recording head for an image recording apparatus ejects ink in a liquid state, and the coloring material ejecting head for a display manufacturing apparatus ejects a solution of each coloring material of R(Red).G(Green).B(Blue). In addition, an electrode material ejecting head for an electrode forming device ejects electrode material in a liquid state, and a bioorganic ejecting head for a chip manufacturing device ejects a bioorganic solution.

Recently, improvement of the ink ejection characteristics (discharging characteristics) of such a printer to cope with high-quality image has been demanded. In particular, due to the production tolerance of the recording head, there may be variations in the ink ejection characteristics (amount or flying speed of the ink ejected or the like) of each recording head. For this reason, after a recording head is manufactured, two-dimensional codes where optimal values of parameters such as a driving voltage required for generating a driving signal for driving a pressure generating unit of the recording head are recorded may be attached to the recording head. In this case, after the recording head is mounted to a printer body, values of the two-dimensional codes are read, and these values are written in a non-volatile storage unit mounted in the printer body. In addition, when the printer performs an ejecting operation, a driving signal is generated based on the optimal values written in the non-volatile storage unit (see JP-A-2002-337348). By doing so, optimal ink ejection characteristics may be obtained for each recording head, and printers of high-quality image may be provided.

This kind of printer is designed to obtain the most preferred printing result in the case where the reference value of the environmental temperature (hereinafter, reference temperature) where the corresponding printer is used is for example 25° C. and the printer is used at that temperature. Generally, the reference temperature is a temperature set in the manufacturing process of the printer or the head unit. However, a user may not necessarily always use the printer at the reference temperature. For example, in the case where the environmental temperature is higher than the reference temperature, each member of the printer may thermally expand, which may cause an error on the impact position of the ink ejected from the nozzle of each recording head to a recording medium. In the same way, in the case where the environmental temperature is lower than the reference temperature, each member may shrink to cause an impact error. In particular, a plurality of recording heads are arranged and fixed to a head fixing member such as sub-carriage to configure a single head unit. In a printer equipped with such a single head unit, as the environmental temperature changes so that the relative positions of the recording heads vary accompanied with the deformation of the sub-carriage, an deviation is caused at the impact position of liquid droplets on the recording medium between the recording heads fixed to the sub-carriage. As a result, the quality of a recorded image or the like may deteriorate.

### SUMMARY

An advantage of some aspects of the invention is that a liquid ejecting apparatus capable of suppressing the deviation in the impact positions of liquid with respect to an impact target even though the environmental temperature changes, and method for manufacturing the same.

According to an aspect of the invention, there is provided a liquid ejecting apparatus, which includes a head unit that includes a liquid ejecting head, which has a nozzle forming surface where a nozzle row having a plurality of nozzles installed in a direction crossing a head movement direction is formed and drives a pressure generating unit to eject liquid from the nozzles so as to impact an impact target, and a head fixing member to which a plurality of the liquid ejecting heads are arranged and fixed; a moving unit that relatively moves the corresponding head unit and the impact target in a head installation direction; a temperature detecting unit that detects an environmental temperature in the liquid ejecting apparatus; a storage unit that stores control information associated with the control of liquid ejection; and a control unit that controls liquid ejection of each liquid ejecting head, wherein the storage unit stores a temperature correction table where the temperature detected by the temperature detecting unit is associated with correction information of liquid ejection timing, and wherein the control unit corrects the liquid ejection timing of each liquid ejecting head with reference to the temperature detected by the temperature detecting unit and the temperature correction table.

According to this aspect, by compensating the liquid ejection timing of each liquid ejecting head with reference to the temperature detected by the temperature detecting unit and the temperature correction table, the deviation in the impact positions of the liquid ejected from each liquid ejecting head to a recording medium may be suppressed.

It is preferable that any one of the liquid ejecting heads fixed to the head fixing member is a reference head, and the correction information is information about correction for the deviation in liquid impact positions on the impact target caused by a change in relative position of each liquid ejecting head with respect to the reference head in the head installation direction, accompanied by the temperature change from a predetermined reference temperature.

In addition, it is preferable that the correction information is determined based on the rate of change of the relative position of each liquid ejecting head with respect to the reference head in the head installation direction, accompanied by the temperature change.

According to this aspect, the gap of the relative position changes with respect to the temperature change for every liquid ejecting head may be reflected on the timing correction. By doing so, the deviation in the impact position may be more reliably suppressed.

It is preferred that the head unit includes a head information recording portion where the relative position changing rate is recorded.

According to this aspect, when each liquid ejecting head of the head unit is repaired or replaced, the information stored in the head information recording portion may be read so that the relative position changing rate is reflected on the adjustment of the impact position.

It is preferred that the head information recording portion stores a changing rate of the liquid impact position in the head installation direction by the inclination of the nozzle forming surface, accompanied by the temperature change from the reference temperature, in addition to the changing rate of the relative position, and the correction information is determined based on the changing rate of the relative position and the changing rate of the impact position.

According to this aspect, the deviation in the impact position caused by the inclination of the nozzle forming surface of the liquid ejecting head when the temperature changes may be reflected on the temperature correction table, and the deviation in liquid impact position may be more reliably suppressed.

It is preferred that the head information recording portion is a two-dimensional code.

According to another aspect of the invention, there is also provided a method for manufacturing a liquid ejecting apparatus including a head unit that includes a liquid ejecting head, which has a nozzle forming surface where a nozzle row having a plurality of nozzles installed in a direction crossing a head movement direction is formed and drives a pressure generating unit to eject liquid from the nozzles so as to impact an impact target, and a head fixing member to which a plurality of the liquid ejecting heads are arranged and fixed; a moving unit that relatively moves the corresponding head unit and the impact target in a head installation direction; a temperature detecting unit that detects an environmental temperature in the liquid ejecting apparatus; a storage unit that stores control information associated with the control of liquid ejection; and a control unit that controls liquid ejection of each liquid ejecting head, the method includes: positioning and fixing each liquid ejecting head to the head fixing member to configure the head unit; setting any one of the liquid ejecting heads as a reference head and obtaining a changing rate of a relative position of each liquid ejecting head with respect to the reference head in the head installation direction, accompanied by the temperature change from a predetermined reference temperature; recording each relative position changing rate obtained in the setting in a head information recording portion, and endowing the head information recording portion to the head unit; assembling the head unit with the liquid ejecting apparatus; creating a temperature correction table where the temperature detected by the temperature detecting unit and the correction information of liquid ejection timing are associated, based on the relative position changing rate recorded in the head information recording portion; and storing the temperature correction table in the storage unit.

### BRIEF DESCRIPTION OF THE DRAWINGS

The invention will be described with reference to the accompanying drawings, wherein like numbers reference like elements.

FIG. 1 is a perspective view showing a part of the inner configuration of a printer.

FIG. 2 is an enlarged view showing a region II of FIG. 1.

FIG. 3 is a front view of the printer.

FIG. 4 is a right side view of the printer.

FIGS. 5A and 5B are diagrams for illustrating the configuration of a carriage assembly.

FIG. 6 is a perspective view for illustrating the configuration of a recording head.

FIG. 7 is a cross-sectional view showing an essential part of the recording head.

FIG. 8 is a block diagram for illustrating the electric configuration of the printer.

FIG. 9 is a waveform showing an example of an ejection driving pulse.

FIG. 10 is a flowchart for illustrating the flow of a head unit manufacturing process.

FIG. 11 is a flowchart for illustrating the flow of a printer body manufacturing process.

FIGS. 12A and 12B are schematic diagrams for illustrating the form of recording an inspection pattern in an impact position deviation measuring process.

FIGS. 13A and 13B are diagrams showing one example of the inspection pattern recorded in a recording paper.

FIG. 14 is a diagram showing an example of a temperature correction table.

FIG. 15 is a flowchart for illustrating a timing correction control.

FIG. 16 is a schematic diagram for illustrating an impact position changing rate obtaining process according to a second embodiment.

### DESCRIPTION OF EXEMPLARY EMBODIMENTS

Hereinafter, embodiments of the invention will be described with reference to the accompanying drawings. In addition, even though the embodiments described below are limited in various ways as very suitable detailed examples, the scope of the invention is not limited to these aspects unless otherwise noted. In addition, an ink jet recording apparatus (hereinafter, a printer) will be described as an example of the liquid ejecting apparatus of the invention.

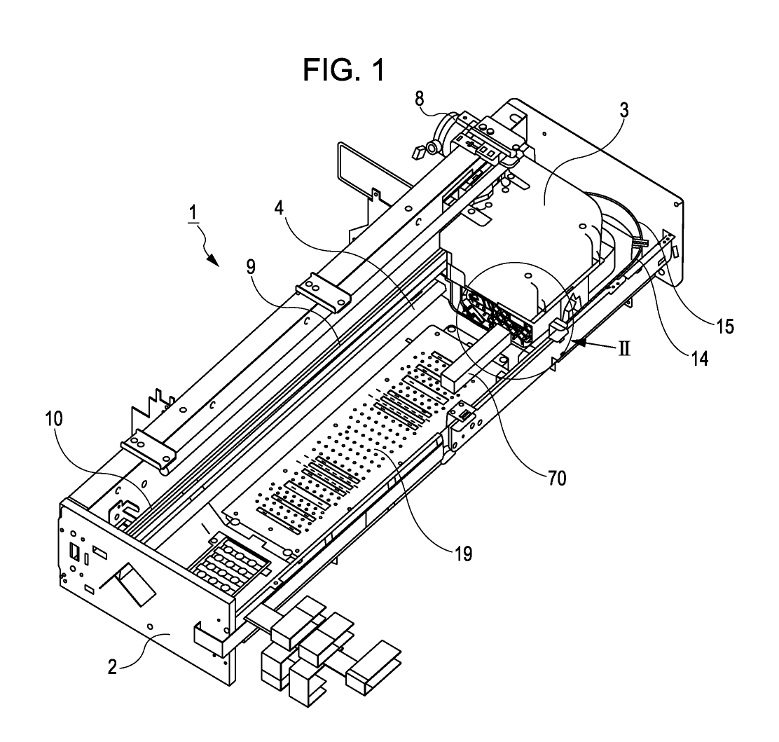

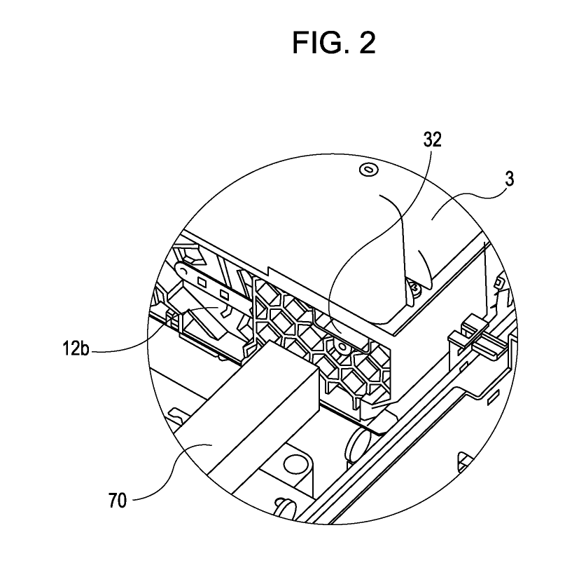

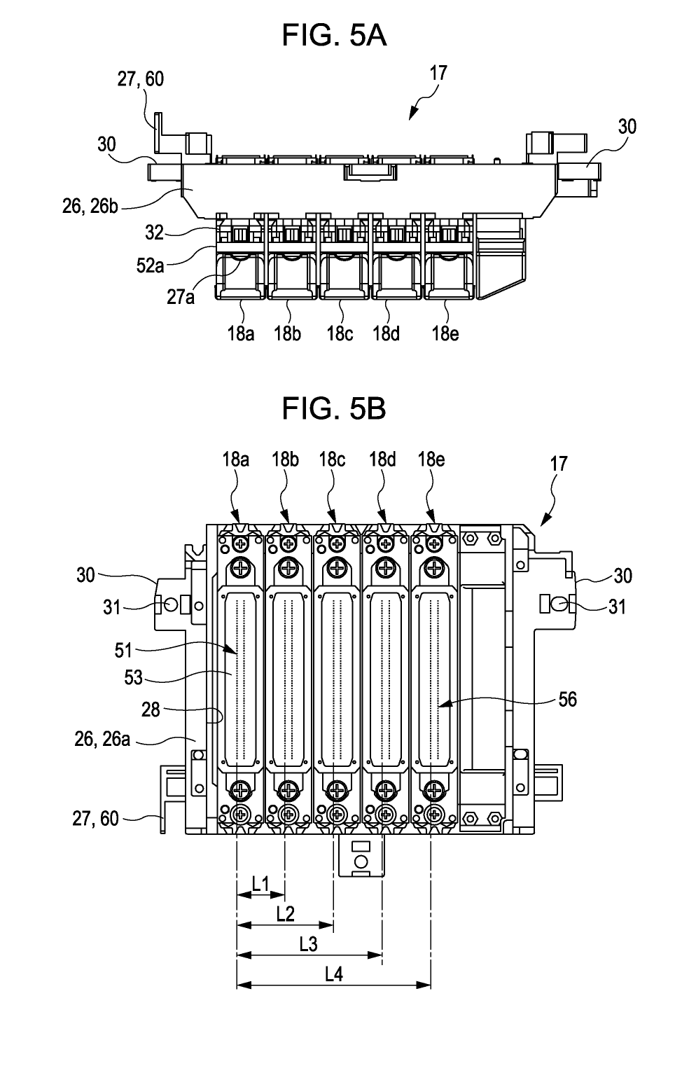

FIG. 1 is a perspective view showing a part of the inner configuration of a printer 1, and FIG. 2 is an enlarged view showing a II region of FIG. 1. The printer 1 illustrated in the figures relatively moves a recording medium (an impact target) such as a recording paper, cloth or film placed on a platen 19 and a head unit 17 (see FIG. 5 or the like) loaded on a carriage assembly 3, and also ejects ink, which is a kind of liquid, from the corresponding head unit 17 toward the recording medium and keeps arranging dots, formed by impacting the corresponding ink onto the recording medium, in a matrix to record (print) an image or text on the recording medium. In the printer 1, the carriage assembly 3 (hereinafter, referred to also as the carriage 3) is mounted in a frame 2 to reciprocate in a main scanning direction (first direction) which crosses the movement direction of the recording medium. At the inner wall of the frame 2 which is at the rear side of the printer 1, a long guide rod 4 is mounted along the main scanning direction. The carriage 3 is slidably supported by a guide rod 4 as the guide rod 4 is fit in a bearing unit 7 (see FIG. 4) installed at its rear side.

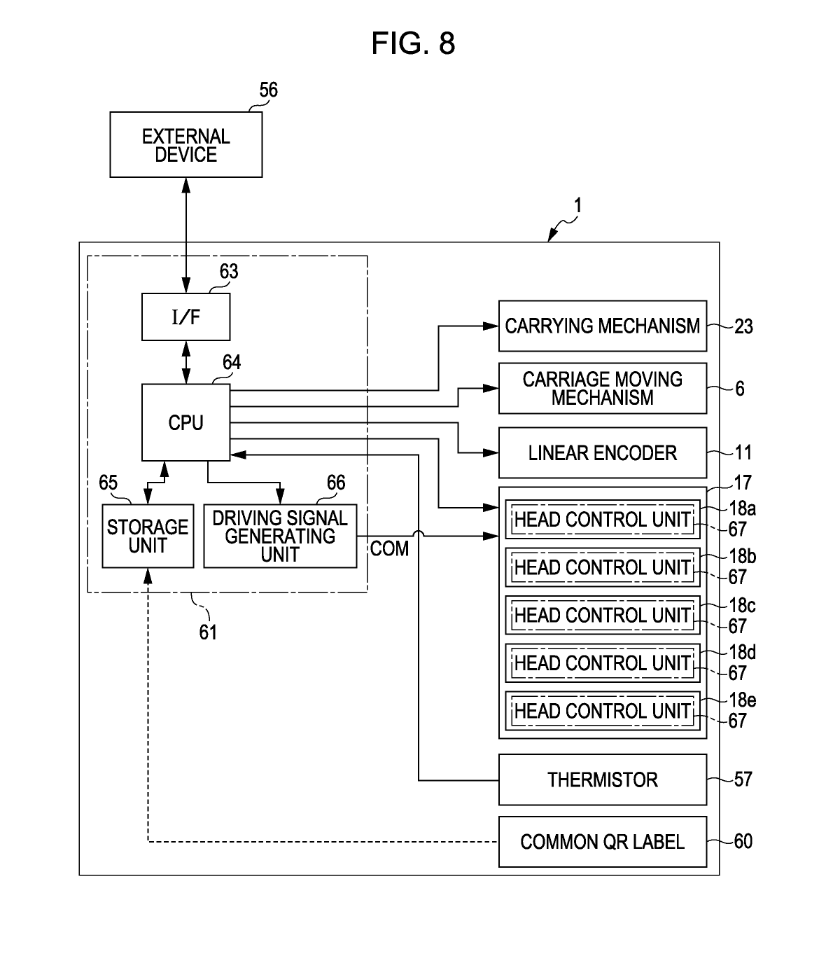

A carriage motor 8 for moving the carriage 3 is installed at one end side (a right end portion in FIG. 2) of the main scanning direction, which is the rear side of the frame 2, as a driving source. A driving shaft of the carriage motor 8 protrudes toward the inner side from the rear side of the frame 2, and a driving pulley (not shown) connects to its front end portion. The driving pulley rotates by the driving of the carriage motor 8. In addition, with respect to the driving pulley, an idle pulley (not shown) is installed at an opposite position in the main scanning direction. A timing belt 9 (see FIG. 1) is installed over such pulleys. The carriage 3 connects to the timing belt 9. In addition, if the carriage motor 8 is driven, the timing belt 9 pivots accompanied with the rotation of the driving pulley, and the carriage 3 moves in the main scanning direction along the guide rod 4. In other words, the carriage motor 8, the driving pulley, the idle pulley, and the timing belt 9 configure a carriage movement mechanism 6. Moreover, the printer 1 includes a transport mechanism 23 (see FIG. 8) which transports a recording paper fed from a feeding tray, not shown, in a sub-scanning direction orthogonal to the main scanning direction.

In the printer 1, a scanning position of the head unit 17 loaded on the carriage 3 is detected by a linear encoder 11. The linear encoder 11 includes a linear scale 10 installed long along the main scanning direction at the inner wall of the rear side of the frame 2, and a detecting unit 16 (FIG. 4) mounted to the rear side of the carriage 3. The detecting method of the linear encoder 11 may be an optical type, a magnetic type or the like, and the printer 1 of this embodiment adopts an optical-type linear encoder 11. The linear scale 10 is a band-shaped member, and in this embodiment, a plurality of longitudinal slits is formed along the longitudinal direction of the base member. Each slit is formed with a constant pitch, for example a pitch corresponding to 180 dpi, in the longitudinal direction of the base member. In addition, the detecting unit 16 includes a pair of light emitting element 16a and light receiving element 16b arranged to face each other, and the linear scale 10 is disposed to pass between the light emitting element 16a and the light receiving element 16b. In addition, the detecting unit 16 is configured to output an encoder pulse according to the difference between the light receiving state at the slit of the linear scale 10 and the light receiving state at a portion other than the slit.

The linear encoder 11 outputs an encoder pulse according to a scanning position of the carriage 3 as position information of the carriage 3 in the main scanning direction. A printer controller 61 (see FIG. 8) described later may recognize the scanning position of the head unit 17 loaded on the carriage 3 based on the encoder pulse accommodated from the linear encoder 11, and control a recording operation of each recording head 18 of the corresponding head unit 17 onto the recording medium. In addition, the printer 1 is configured to enable a so-called bi-direction recording process which records texts, images or the like on a recording paper bi-directionally, during a outward movement where the carriage 3 moves from a home position at one end side of the main scanning direction to an end (full position) at the opposite side and during a returning movement where the carriage 3 returns from the full position to the home position.

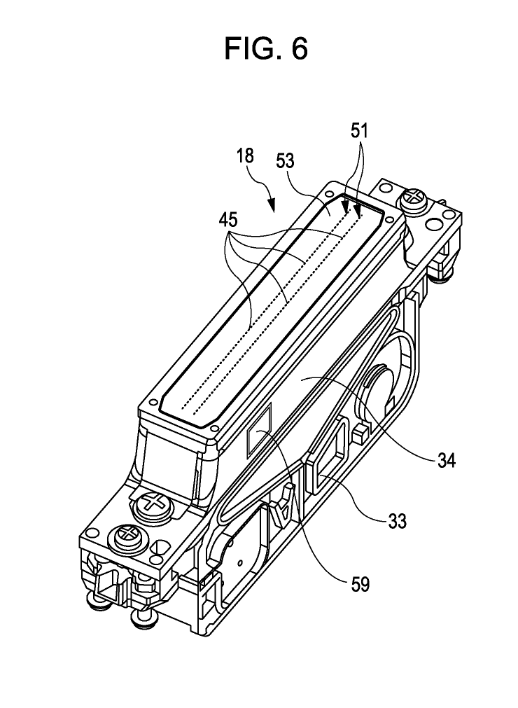

An ink supply tube 14 for supplying each color of ink to each recording head 18 of the head unit 17 and a signal cable 15 for supplying a signal such as an operation signal connect to the carriage 3. In addition, though not shown in the figures, a cartridge mounting portion to which an ink cartridge (a liquid supply source) storing ink is detachably mounted, a capping portion for capping a nozzle forming surface 53 (see FIG. 6) of the recording head 18 in a standby state, or the like are installed at the printer 1.

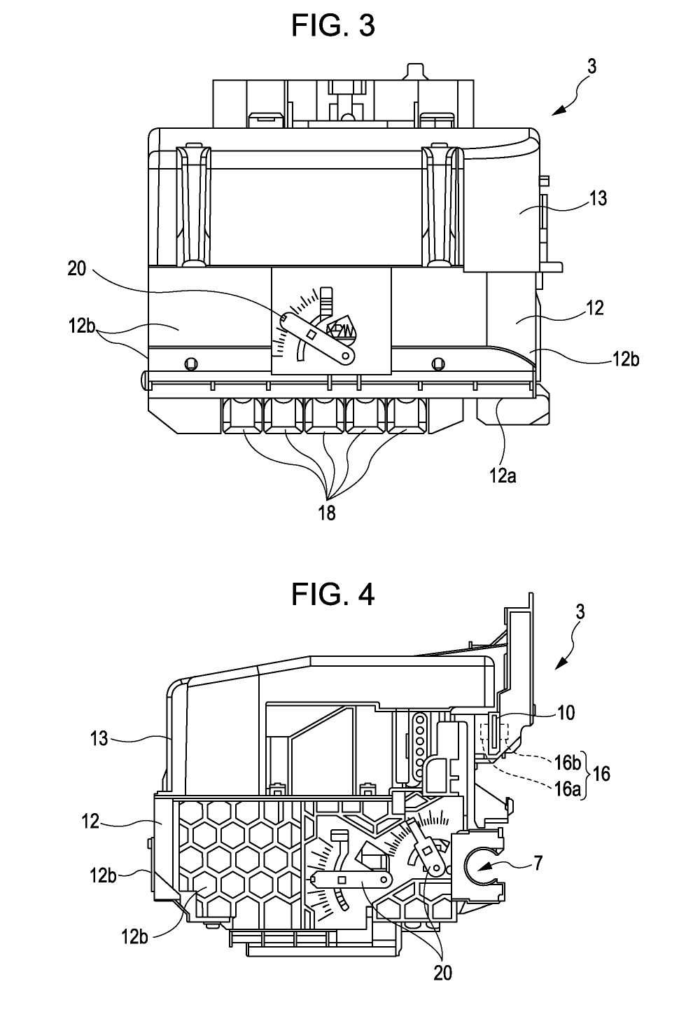

FIG. 3 is a front view of the carriage 3, and FIG. 4 is a right side view of the carriage 3.

The carriage 3 includes a carriage body 12 in which the head unit 17, described later, is loaded, and a carriage cover 13 covering an upper opening of the carriage body 12, and the carriage 3 is a member with a hollow box shape which may be vertically separated. The carriage body 12 has a substantially rectangular bottom plate portion 12a and sidewall portions 12b standing up respectively in four direction from the outer circumferential edge of the corresponding bottom plate portion 12a, and the head unit 17 is accommodated in the space surrounded by the bottom plate portion 12a and the sidewall portions 12b. At the bottom plate portion 12a, an opening (not shown) is formed to expose the nozzle forming surface 53 of each recording head 18 of the accommodated head unit 17. In addition, in the state where the head unit 17 is accommodated in the carriage body 12, the nozzle forming surface 53 of each recording head 18 protrudes from the opening of the bottom plate portion 12a further to the bottom portion of the carriage body 12 (toward the recording medium during the recording operation).

Between the carriage body 12 and the head unit 17, an adjustment mechanism such as an eccentric cam, not shown, is interposed for adjusting the posture of the head unit 17 accommodated in the corresponding carriage body 12. In addition, at the carriage body 12, a plurality of adjustment levers 20 for manipulating such an adjustment mechanism are installed. By the manipulation of the adjustment lever 20, the posture of the head unit 17 accommodated in the carriage body 12, such as the position with respect to the carriage body 12 (the height based on the platen 19 or position in the main scanning direction and the sub-scanning direction) or the inclination (the inclination around a virtual axis of the main scanning direction and the inclination around a virtual axis of the sub-scanning direction) may be adjusted.

FIGS. 5A and 5B are diagrams for illustrating the configuration of the head unit 17, where FIG. 5A is a front view and FIG. 5B is a bottom view.

The head unit 17 is a unit configured by fixing a plurality of recording heads 18 to a sub-carriage 26 (a kind of head fixing member in the invention). The sub-carriage 26 includes a base portion 26a having a plate shape to which the recording head 18 is fixed, and standing wall portions 26b standing upwards respectively from in four direction from the outer circumferential edge base portion 26a, and has a hollow box shape with the upper face opened. The space formed by the base portion 26a and the four standing wall portions 26b serves as a receiving portion receiving at least a part (mainly a sub-tank 33) of the recording head 18.

A head insert opening 28 into which a plurality of recording heads 18 may be inserted (in other words, a single head insert opening common to each recording head 18) is installed at a substantially center portion of the base portion 26a of the sub-carriage 26. For this reason, the base portion 26a becomes a frame with four sides. At the lower surface of the base portion 26a (the surface opposite the recording medium during the recording operation), a fixing hole, not shown, is installed corresponding to the installation position of each recording head 18.

In this embodiment, five recording heads 18 including a first recording head 18a, a second recording head 18b, a third recording head 18c, a fourth recording head 18d, and a fifth recording head 18e are accommodated in the receiving portion by inserting a sub-tank 33, described later, from the lower portion of the head insert opening 28, and fixed respectively by screws in a state of being positioned at the base portion 26a in parallel to the direction orthogonal to the nozzle row (the main scanning direction in a state of being assembled to the printer 1). In addition, the recording head 18 is fixed to the sub-carriage 26 so that the arrangement of ink colors which can be respectively allocated to each nozzle row 51 becomes symmetric from the center of the head installation direction (namely, the main scanning direction during the recording and printing operations) in the same direction. For example, black ink, yellow ink, light blue ink, cyan ink and magenta ink are symmetrically arranged in order from the center in the head installation direction toward both outer sides in the corresponding direction. By adopting the position relation of each recording head 18, the impact order of each ink color to the recording medium in the forward path and the returning path may be arranged. By doing so, dots of different colors overlap in a reciprocating order, and thus it is possible to suppress the deterioration in image quality of a recorded image or the like.

On three of the four standing wall portions 26b of the sub-carriage 26, flange portions 30 are installed to protrude in the side direction. At the flange portion 30, insert holes 31 are respectively installed corresponding to three installation screw holes, not shown, formed at the installation positions of the head units 17 of the bottom plate portion 12a of the carriage body 12. In addition, at each installation screw hole of the bottom plate portion 12a of the carriage body 12, in a state of matching the position of each corresponding insert hole 31, a head unit fixing screw 22 is fixed through the insert hole 31 in the installation screw hole, so that the head unit 17 is accommodated and fixed in the carriage body 12. In addition, at the upper portion of the sub-carriage 26, a channel member, not shown, for supplying ink from an ink cartridge to each recording head 18 is mounted. The ink passing through the channel member flows into the sub-tank 33 of each recording head 18.

In addition, at the upper end portion of the standing wall portion 26b which is at the full position side in the main scanning direction among four standing wall portions 26b of the sub-carriage 26, a label adhesion portion 27 is formed in the side direction (toward the full position). At the label adhesion portion 27, a shared QR label 60, described later, is attached. In addition, at the position opposite the label adhesion portion 27 in a state where the head unit 17 is accommodated in the carriage body 12, a window portion 32 formed through the plate thickness direction of the sidewall portion 12b is installed (see FIG. 2).

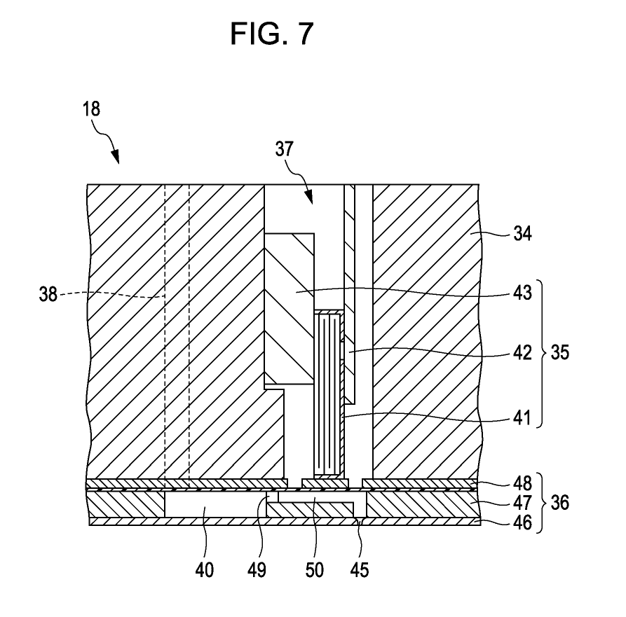

FIG. 6 is a perspective view (showing a state observed from the nozzle forming surface 53) for illustrating the configuration of each recording head 18 (a kind of liquid ejecting head) mounted to the sub-carriage 26, and FIG. 7 is a cross-sectional view showing an essential part of the recording head 18. In addition, since a basic structure or the like is common to the recording heads 18, one of five recording heads 18 mounted to the sub-carriage 26 is shown representatively.

The recording head 18 includes a sub-tank 33, a head case 34, a vibrator unit 35, and a channel unit 36. The sub-tank 33 is a member for supplying the ink from the ink cartridge to a pressure chamber of the recording head 18. The sub-tank 33 opens or closes the valve according to the change of inner pressure and has a self-sealing function for controlling the supply of the ink to the pressure chamber. At the spaced portion formed at the center region of the sub-tank 33, a driving substrate for controlling the application of a driving signal (an ejection driving pulse) for a piezoelectric element 41 serving as a pressure generating unit is installed (not shown). At the driving substrate, electric parts such as a driving IC serving as a head control unit 67 are mounted, and simultaneously the signal cable 15 and a flexible cable 42 are electrically connected. In addition, the driving substrate supplies the driving signal sent through the signal cable 15 from the controller of the printer 1 to a vibrator unit 35 through the flexible cable 42.

The head case 34 is a member with a hollow box shape, the channel unit 36 is fixed at its front end side (the lower side), the vibrator unit 35 is accommodated in a receiving spaced portion 37 formed in the case, and the sub-tank 33 and the driving substrate are disposed at the surface opposite the front end side. The upper surface of the head case 34 is a base end surface of the recording head 18. In addition, at the inside of the head case 34, a case channel 38 is formed through its height direction. The case channel 38 is a channel for supplying the ink at the sub-tank 33 to a shared liquid chamber (also called a reservoir or manifold) 40, and two case channels are installed for each shared liquid chamber 40. Each recording head 18 of this embodiment has two shared liquid chambers 40 corresponding to two groups of nozzle rows 51 (nozzle groups), and four case channels 38 are formed in the head case 34 in total.

The vibrator unit 35 includes a plurality of piezoelectric elements 41 installed with a comb tooth shape, a flexible cable 42 (a wiring member) for supplying a driving signal from the driving substrate to the piezoelectric element 41, and a fixing plate 43 for fixing the piezoelectric element 41. The piezoelectric element 41 adheres to a flexible surface (a vibration plate 48) which configures a part of the pressure chamber 50. In addition, the piezoelectric element 41 expands or shrinks by the applied driving signal to increase or decrease the capacity of the pressure chamber 50 so that the pressure applied to the ink in the pressure chamber 50 changes, thereby ejecting the ink from the nozzle 45 by the control of the pressure change.

The channel unit 36 is manufactured by adhering and assembling a nozzle forming substrate 46 having nozzles 45, a channel forming substrate 47 forming ink channels, and a vibration plate 48 sealing the opening surface of the channel forming substrate 47 in a laminated state, and is a unit member forming a series of ink channels (liquid channels) from the shared liquid chamber 40 through the ink supply opening 49 and the pressure chamber 50 to the nozzle 45. The pressure chamber 50 diverged from the shared liquid chamber 40 is formed at each nozzle 45, and is configured so that the ink is supplied from the sub-tank 33 through the case channel 38 and the shared liquid chamber 40. The channel unit 36 is adhered to the front end surface of the head case 34 disposed toward the lower side of the nozzle forming substrate 46 (toward the plate 19 of the printer body).

The nozzle forming substrate 46 is a member perforating a plurality (for example, 180) of nozzles 45 of a pitch (for example 180 dpi) corresponding to the dot forming density with a row shape along the direction corresponding to the sub-scanning direction during the recording operation, and in this embodiment, for example, is made of dotless steel. The lower surface of the nozzle forming substrate 46 (the side opposite the recording medium during the recording operation) is the nozzle forming surface 53. At the nozzle forming substrate 46 of this embodiment, two nozzle rows 51 are arranged along the main scanning direction (the head installation direction). In addition, the nozzle forming substrate 46 may be occasionally made of silicon single crystal substrate or other materials.

Next, the electric configuration of the printer 1 will be described.

FIG. 8 is a block diagram for illustrating the electric configuration of the printer 1. An external device 56 is an electronic device such as a computer and a digital camera. The external device 56 connects to the printer 1 to be capable of communicating, and in the printer 1, in order to print an image or text on a recording medium such as a recording paper, print data according to the image or the like is transmitted to the printer 1.

The printer 1 of this embodiment includes a transport mechanism 23, a carriage movement mechanism 6 (corresponding to the moving portion of the invention), a linear encoder 11, a head unit 17, a thermistor 57 (corresponding to the temperature detecting unit of the invention), and a printer controller 61 (corresponding to the control unit of the invention). The thermistor 57 is installed near each recording head 18, in detail for example at the sub-carriage 26, the driving substrate or the like, and detects the temperature around the head unit 17 to output the corresponding detection signal to a CPU 64 of the printer controller 61.

The printer controller 61 is a control unit that controls each part of the printer. The printer controller 61 includes an interface (I/F) unit 63, a CPU 64, a storage unit 65, and a driving signal generating unit 66. The interface unit 63 transmits or receives printer state data by sending print data or print command from the external device to the printer 1 or receiving the state information of the printer 1 in the external device. The CPU 64 is an operation device for controlling the entire printer. The storage unit 65 is a device storing data used for various programs or controls of the CPU 64, and includes ROM, RAM, and NVRAM (non-volatile storage element). The CPU 64 controls each unit according to the program loaded at the storage unit 65.

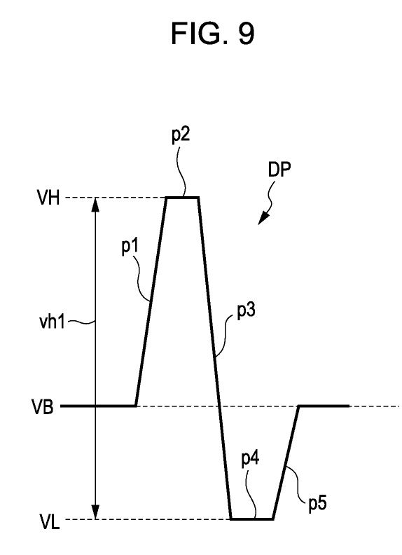

The CPU 64 serves as a timing pulse generating unit for generating timing pulse PTS from an encoder pulse EP output from the linear encoder 11. The timing pulse PTS is a signal determining a timing when the driving signal generating unit 66 initiates generation of the driving signal COM. In other words, the driving signal generating unit 66 outputs a driving signal COM whenever receiving the timing pulse. In addition, for example, in the case where the timing pulse PTS is output at an interval corresponding to 720 dpi of the dot formation resolution (a ink impact interval based on the design or specification, also called a raster resolution), since the encoder pulse EP is generated at an interval corresponding to 180 dpi, the CPU 64 multiplies the encoder pulse EP by 4 to generate the timing pulse PTS. In addition, the CPU 64 is synchronized with the timing pulse PTS to control the transmission of print data or the generation of a driving signal COM by the driving signal generating unit 66. In addition, the CPU 64 generates a timing signal such as a latch signal LAT or the like based on the timing pulse PTS and outputs the timing signal to the head control unit 67 of each recording head 18. Each head control unit 67 controls the application of the ejection driving pulse DP (see FIG. 9) of the driving signal COM with respect to the piezoelectric element 41 of the recording head 18, based on the head control signal (the print data and the timing signal) from the printer controller 61.

The driving signal generating unit 66 generates an analog voltage signal based on the waveform data regarding the waveform of the driving signal sent from the printer controller 61. In addition, the driving signal generating unit 66 amplifies the voltage signal to generate the driving signal COM. The driving signal COM is applied to the piezoelectric element 41 which is a pressure generating unit of the recording head 18 when a printing operation (a recording operation or an ejecting operation) is performed to the recording medium, and is a series of signals including at least one ejection driving pulse DP shown in FIG. 9 within a unit period which is a repeating period. Here, the ejection driving pulse DP performs a predetermined operation to the piezoelectric element 41 in order to eject ink of a liquid droplet shape from the nozzle 45 of the recording head 18.

FIG. 9 is a waveform showing an example of the ejection driving pulse DP included in the driving signal COM. In addition, in FIG. 9, the vertical axis represents a potential, and the horizontal axis represents time. The ejection driving pulse DP shown in the figure includes an expansion element p1 where the potential changes from a reference potential (a intermediate potential) VB to an expansion voltage VH in a positive side to expand the pressure chamber 50, an expansion maintaining element p2 for maintaining the expansion voltage VH for a predetermined time, a shrinkage element p3 where the potential changes from the expansion voltage VH to the shrinkage potential VL in a negative side to rapidly shrink the pressure chamber 50, a shrinkage maintaining (returning holding) element p4 for maintaining the shrinkage potential VL for a predetermined time, and a returning element p5 where the potential returns from the shrinkage potential VL to the reference potential VB.

If the ejection driving pulse DP is applied to the piezoelectric element 41, the following operation occurs. First, the piezoelectric element 41 shrinks by the expansion element p1, and accompanied with it, the pressure chamber 50 expands from a reference capacity corresponding to the reference potential VB to a maximum volume corresponding to the highest potential VH. By doing so, the meniscus exposing to the nozzle 45 is pulled toward the pressure chamber. The expanded state of the pressure chamber 50 is consistently maintained during a time that the expansion maintaining element p2 is applied. If the shrinkage element p3 is applied to the piezoelectric element 41 in succession with the expansion maintaining element p2, the corresponding piezoelectric element 41 is elongated, and by doing so, the pressure chamber 50 rapidly shrinks from the maximum capacity to a minimum capacity corresponding to the lowest potential VL. By the rapid shrinkage of the pressure chamber 50, the ink in the pressure chamber 50 is pressed, and by doing so, several p1 to several tens of p1 of ink is ejected from the nozzle 45. The shrunk state of the pressure chamber 50 is maintained for a short time during the time when the shrinkage maintaining element p4 is applied, and after that, the returning element p5 is applied to the piezoelectric element 41, so that the pressure chamber 50 returns from the capacity corresponding to the lowest potential VL to the reference capacity corresponding to the reference potential VB.

Next, the manufacturing process of the printer 1 will be described. The manufacturing process of the printer 1 is generally classified into a head unit manufacturing process and a printer body manufacturing process.

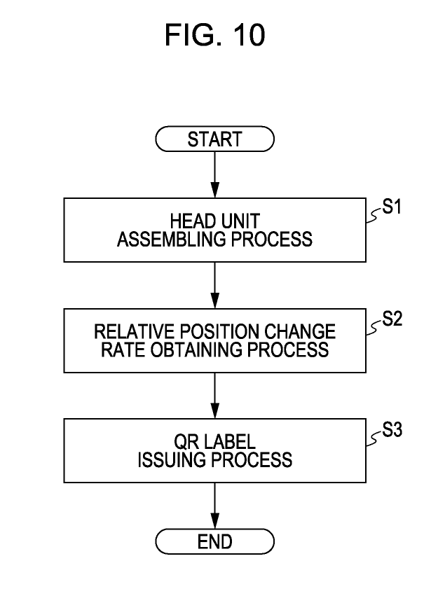

FIG. 10 is a flowchart for illustrating the head unit manufacturing process.

In a head unit assembling process S1, first, each recording head 18 to be installed at the sub-carriage 26 is manufactured. After being manufactured, each recording head 18 actually ejects ink or a test liquid having the same characteristics from the nozzle 45 to measure a suitable voltage of the driving signal to obtain ejection characteristics (amount or flying speed of the ink ejected) or targeted ejection characteristics in its design or specification. Inherent information of each recording head 18 such as the above measurement values or the like (for example, the inherent information includes an inherent vibrating period of the pressure chamber 50) is converted into a two-dimensional code (a so-called QR Code™). A label where the corresponding two-dimensional code is printed is an individual QR label 59, which is adhered to a side or the like of the head case 34 (see FIG. 6).

Next, each recording head 18a to 18e is fixed in a state of being positioned (alignment) with respect to the sub-carriage 26. In the positioning process, for example, while observing the nozzle forming surface 53 of the recording head 18, which will be installed, set to a head attaching unit of the base portion 26a of the sub-carriage 26 by using a photographing unit such as a CCD camera, the position of the recording head 18 on the base portion 26a is adjusted so that a plurality (at least two) of specific nozzles 45 of the corresponding nozzle forming surface 53 are positioned at regulated positions. If the recording head 18 to be installed is positioned with respect to the sub-carriage 26, the recording head 18 is provisionally fixed by an adhesive and then finally fixed by screwing. In this way, the head unit 17 may be assembled.

Here, in the printer 1, the reference value of the environmental temperature at which the corresponding printer 1 is used is set to be, for example 25° C., and the printer 1 is designed to obtain the most preferred printing result when being used at the reference temperature. However, the environment where the user uses the printer 1 may not be always at the reference temperature. Even though each recording head 18a to 18e is fixed in a state of being positioned with high precision with respect to the sub-carriage 26 as described above, for example, in the case where the environmental temperature is higher than the reference temperature, the relative position of each recording head 18a to 18e may deviates as each member of the printer 1, particularly the sub-carriage 26, expands. By doing so, an error may occur in the impact position of the ink ejected from the nozzle 45 of each recording head 18 onto the recording medium. In the same way, in the case where the environmental temperature is lower than the reference temperature, an impact error may occur as each member shrinks. For this reason, in a state where the head unit 17 is assembled, any one of the recording heads 18a to 18e is set as a reference head, and a relative distance (interval) of other recording head 18 with respect to the reference head in the head installation direction (main scanning direction), accompanied by the temperature change from a reference temperature, thereby obtaining its changing rate (a relative position changing rate obtaining process S2).

In the relative position changing rate obtaining process, for example, the head unit 17 is accommodated in a desiccator, the internal temperature of the corresponding desiccator is set to a plurality of values in the temperature range available for the printer 1, and a changing rate of the relative position of each recording head 18 with respect to the reference head at each temperature in the main scanning direction is measured. In this embodiment, relative distances are respectively measured at 10° C., 25° C., and 40° C. when the reference temperature is 25° C. In addition, the set temperature value or the set number may change as desired. In addition, in this embodiment, the first recording head 18a becomes the reference head, and as shown in FIG. 5B, each distance L1 to L4 from one nozzle row 51 at one side (a left one in FIG. 5B) between two nozzle rows 51 of the corresponding first recording head 18a to one nozzle row 51 of residual recording head 18b to 18e is respectively measured at each set temperature. Since the temperature and the distance between heads almost have a proportional relationship, the measurement result at each set temperature is linearly approximated to obtain its inclination α (mm/° C.), and the corresponding inclination becomes a relative position changing rate. In other words, in the relative position changing rate obtaining process, changing rates (inclinations α1 to α4) for the temperatures with respect to L1, L2, L3, and L4 are respectively obtained.

The relative position changing rate obtained in the relative position changing rate obtaining process is converted into two-dimensional codes together with the information read from the individual QR label 59 of each recording head 18 or other control information, and is adhered to the label adhesion portion 27 of the sub-carriage 26 as a shared QR label 60 common to the recording heads 18 (a QR label issuing process S3 (corresponding to a head information recording portion endowing process of the invention)). The shared QR label 60 serves as the head information recording portion in the invention.

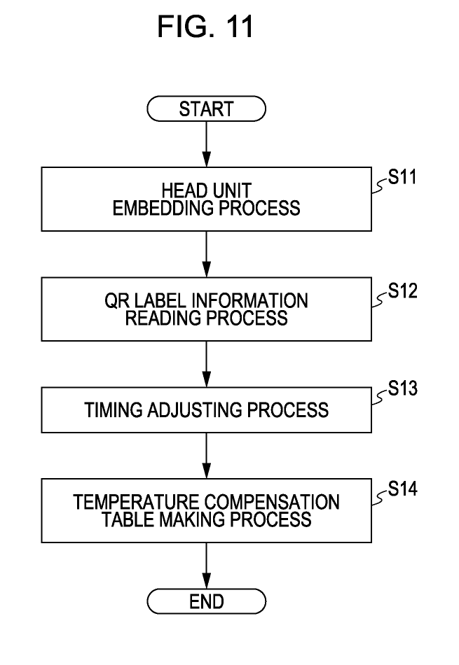

FIG. 11 is a flowchart for illustrating the flow of the printer body manufacturing process.

First, the head unit 17 manufactured through the head unit manufacturing process is assembled with the body of the printer 1 (a head unit assembling process S11). In this process, the head unit 17 is accommodated in the carriage body 12 and fixed by screwing. In addition, in the step before the head unit 17 is screwed with respect to the carriage body 12, the posture of the head unit 17 such as a position or inclination with respect to the carriage body 12 is adjusted by the manipulation of the adjustment lever 20. In addition, components necessary to the printer 1 may be installed.

If the head unit 17 is assembled with the printer 1, as shown in FIG. 2, the information of the shared QR label 60 is read from the window portion 32 of the carriage body 12 by using a QR label reader 70 (a QR label information reading process S12). The read information is stored in a non-volatile storage device of the storage unit 65. Subsequently, the deviation in the impact positions between the recording heads 18 is measured, and ink ejection timing of each recording head 18 is adjusted based on the measurement result (a timing adjusting process S13). In detail, first, at the reference temperature (25° C. in this embodiment), ink is actually ejected from each recording head 18 to a recording paper to record an inspection pattern, so that the deviation from a target position is measured based on the corresponding inspection pattern.

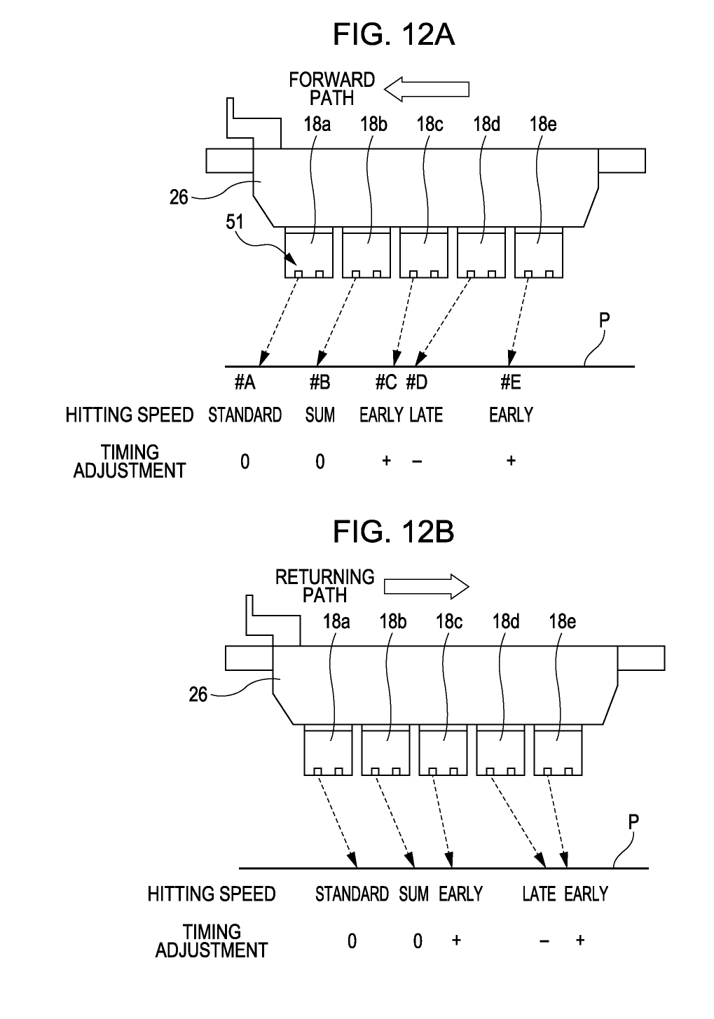

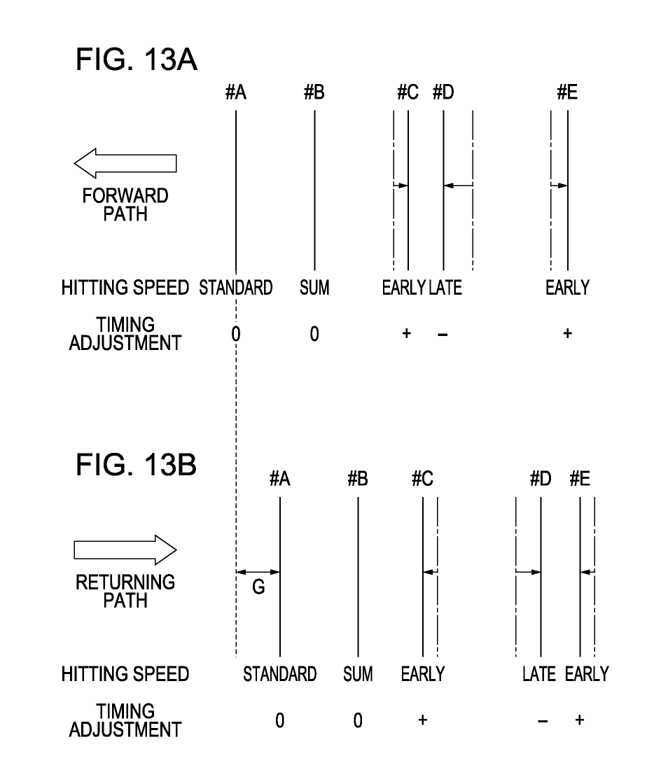

FIGS. 12A and 12B are schematic views showing for illustrating the form of recording an inspection pattern in the impact position deviation measuring process, where FIG. 12A shows the state during a outward movement and FIG. 12B shows the state during a returning movement. In addition, FIGS. 13A and 13B are diagrams showing one example of the inspection pattern recorded in a recording paper, where FIG. 13A shows the inspection pattern during the outward movement and FIG. 13B shows the inspection pattern during the returning movement. In addition, in FIGS. 13A and 13B, a chain line is a virtual rule representing a target impact position. As shown in FIGS. 13A and 13B, in the impact inspection, by simultaneously ejecting ink from each nozzle 45 of the nozzle row 51 at one side (in this embodiment, the left nozzle row 51 in FIGS. 12A and 12B) of each recording head 18a to 18e in both sides of reciprocation at a predetermined timing, vertical rules #A to #E (inspection patterns) along the sub-scanning direction with respect to the recording paper P are arranged and recorded in the main scanning direction, and the deviation from a target position in the main scanning direction of each vertical rule is measured. In addition, the difference in ejection characteristics of nozzle rows 51 in the same recording head 18 is negligible.

In this embodiment, based on the vertical rule #4 of the first recording head 18a which is a reference head, it is inspected how much deviating from the target relative position (namely, the rule represented by the chain line) in the main scanning direction. The deviation in the impact positions at this time is generated by complex factors such as the difference on relative position of each recording head 18, the inclination of the nozzle forming surface 53 (or the nozzle 45), gap in ejection characteristics, or the like. For example, regarding the second recording head 18b, since the relative position or ejection characteristics of the first recording head 18a is in an ideal state, the vertical rule #B formed at the second recording head 18b is formed at a target position (this state is indicated as “matching” state). On the other hands, regarding the third recording head 18c, due to the factors such as the relative position or the difference in ejection characteristics with respect to the first recording head 18a, ink impacts the recording paper P earlier than the ideal state, and therefore the vertical rule #C deviates and is formed at the upstream side in the head advancing direction (the main scanning direction) with respect to the target position (this state is indicated as “early”). In addition, regarding the fourth recording head 18d, ink impacts the recording paper P later than the ideal state, and by this, the vertical rule #D deviates and is formed at the downstream side in the main scanning direction (the head advancing direction) with respect to the target position (this state is indicated as “late”). Simultaneously, regarding the fifth recording head 18e, ink impacts the recording paper P earlier than the ideal state, and by this, the vertical rule #E deviates and is formed at the upstream side in the head advancing direction with respect to the target position (“early”).

In addition, regarding the impact position of the ink ejected from the first recording head 18a which is a reference head, a deviation occurs between the forward path and the returning path. It is for the ink ejected from the recording head 18 to obliquely fly with respect to the recording paper P, as shown in FIGS. 12A and 12B, and in the case where ink is ejected at the timing when the positions in the main scanning direction with respect to the recording paper P in the forward path and the returning path are identical, the impact position of the ink onto the recording paper P deviates in the main scanning direction. FIGS. 13A and 13B show this deviation amount as G.

In addition, a deviation amount from the target position of various rules and an impact position deviation amount G during the reciprocation of the reference head are measured from the inspection pattern, and the timing adjustment amount is set to reflect the deviation on the ink ejection timing. In this embodiment, in relation to the adjustment amount (adjustment resolution) on the deviation in the impact positions, 0.009 mm (≈2880 dpi) is used as a unit, which is one count. In other words, for example, in the case where ink impacts the recording paper P earlier than the ideal state so that the impact position is formed at the upstream side in the head advancing direction with respect to the target position to be deviated by 0.010 mm, the timing adjustment amount (adjustment count value) is set to be +1. Accordingly, based on the distance from the nozzle 45 to the recording paper P, the head (carriage) moving velocity, and the flying speed of the ink, for the time when the ink impact position seems to be distorted at the downstream side by only 0.009 mm in the main scanning direction, the generating timing of the ejection driving pulse DP in the driving signal COM is set to be later. In addition, in the case where the ink impacts the recording paper P later than the ideal state so that the impact position deviates and is formed by 0.010 mm at the downstream side in the head advancing direction with respect to the target position, the timing adjustment amount (adjustment count value) is set to be −1. Accordingly, for the time when the ink impact position seems to be deviated by 0.009 mm at the upstream side in the main scanning direction, the generating timing of the ejection driving pulse DP in the driving signal COM is set to be earlier. In addition, data of the timing-adjusted driving signal COM is stored in the storage unit 65 as initial values (default). Therefore, the timing correction according to temperature change, described later, is performed by the driving signal COM of the initial value. In addition, the adjustment resolution is not limited to the above, and it may be higher or lower than the above.

As described above, by performing the timing adjustment to the driving signal COM based on the inspection pattern, the deviation in ink impact positions of each recording head 18 is suppressed in the case where the recording operation is performed at the reference temperature. However, in the case where the environmental temperature where the printer 1 is used changes from the reference temperature, as described above, the deviation in the impact positions occurs due to the change of relative positions of the recording heads 18a to 18e caused by expansion or shrinkage of the sub-carriage 26. Therefore, in order to reflect the deviation in the impact positions on the generating timing of the ejection driving pulse DP in the driving signal COM, a temperature correction table recording a timing correction amount for temperature is made based on the relative position changing rate read from the shared QR label 60 and stored in the storage unit 65 (a temperature correction table creating process S14).

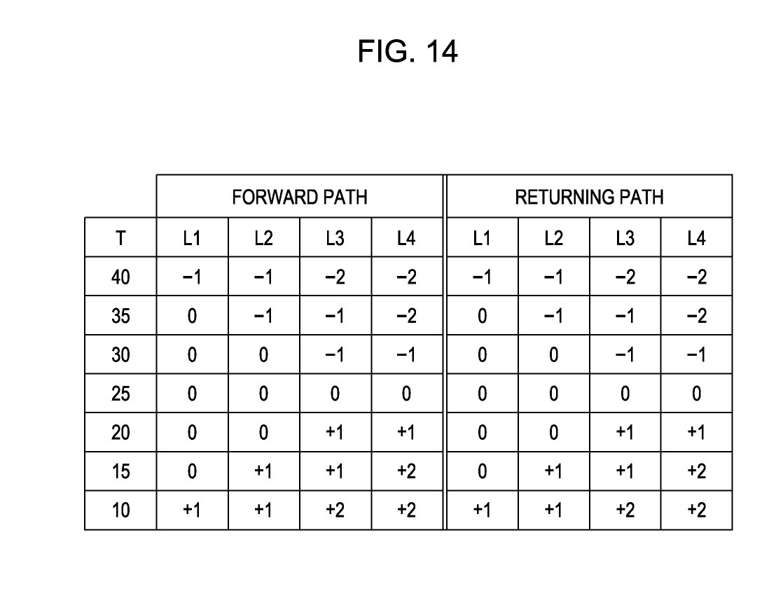

FIG. 14 is a diagram showing an example of the temperature correction table. In this embodiment, 25° C. is set to be the reference temperature, and timing correction values during the outward movement and the returning movement are set 7 temperature stages in total, each 5° C. from 10° C. to 40° C. In the temperature correction table creating process, first, the relative position changing rate stored in the storage unit 65 is read, and a declination (=αT−β (β: a constant to make the deviation be 0, in the case of the reference temperature)) of L1 to L4 at each temperature when the case of the reference temperature becomes 0 from the relative position changing rate, namely the inclination α1 to α4 (mm/° C.). This declination may be used as correction information of the invention to create a table, and this table may be used as the temperature correction table, but in this embodiment, the declination is converted into a correction count value (timing correction amount) using 0.009 mm as one count, and then a table corresponding to temperature is made, so that this table becomes the temperature correction table. Therefore, in this embodiment, the correction count value is a kind of correction information (namely, information about the correction of the deviation of the ink impact position on the recording medium) of the invention. This temperature correction table is stored in the storage unit 65. In addition, the temperature correction table may be converted into two-dimensional codes, and be adhered to the head unit 17 or the like as a QR label. In this case, when the head unit 17 is used again or the like, the relative position changing rate obtaining process may not be performed again, conveniently.

The printer 1 is manufactured through the above processes. Next, the timing correction control using the temperature correction table will be described.

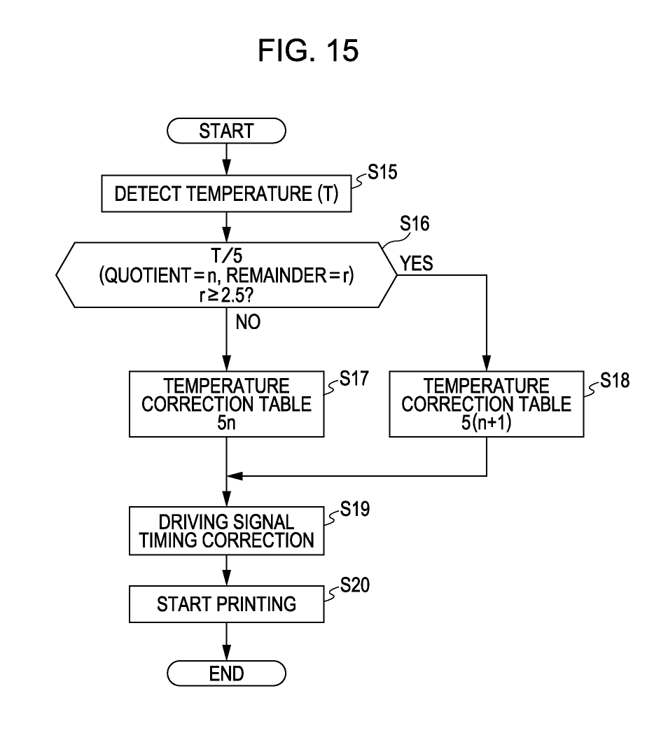

FIG. 15 is a flowchart for illustrating the timing correction control when the printer 1 is used. In the printer 1 of the invention, temperature T is detected by the thermistor 57 at regular cycles or whenever a predetermined operation is performed (a temperature T detecting process S15). The printer controller 58 selects a temperature correction table to be referred to based on the temperature T detected by the thermistor 57. In detail, first, the detected temperature T is divided by 5 to obtain a quotient n and a remainder r. In addition, it is determined whether the remainder r is 2.5 or above (S16). In the case where it is determined that r<2.5 (No), a temperature correction table corresponding to temperature=5 n is selected (S17). Meanwhile, in the case where it is determined that r≧2.5 (Yes), a temperature correction table corresponding to temperature=5 (n+1) is selected (S18). For example, in the case where the detected temperature T is 32° C., it becomes 32/5=6 . . . 2 (n=6, r=2), r<2.5, and thus a temperature correction table corresponding to 5 n=30° C. is selected. In addition, for example, in the case where the detected temperature T is 33° C., it becomes 33/5=6 . . . 3 (n=6, r=3), r2.5, and thus a temperature correction table corresponding to 5(n+1)=35° C. is selected.

Next, based on the selected temperature correction table, timing correction is performed to the driving signal COM (a driving signal timing compensating process S19). For example, in the case where the temperature correction table corresponding to 35° C. is selected, since the correction count value of the forward path and the returning path for L1 is 0, timing correction is not performed to the driving signal COM used for the first recording head 18a (the reference head) and the second recording head 18b. In addition, the correction count value of the forward path and the returning path for L2 and L3 is −1. Accordingly, regarding the driving signal COM used for the third recording head 18c and the fourth recording head 18d, the generating timing of the ejection driving pulse DP is corrected to be earlier for the time when the ink impact position in the main scanning direction seems to be deviated only by 0.009 mm at the downstream side. Further, since the correction count value of the forward path and the returning path for L4 is −2, regarding the driving signal COM used for the fifth recording head 18e, the generating timing of the ejection driving pulse DP is corrected to be earlier for the time when the ink impact position in the main scanning direction seems to be deviated by 0.018 mm at the downstream side.

By doing so, timing correction is performed for the driving signal COM according to the temperature detected by the thermistor 57. In addition, the ink ejection control of each recording head 18a to 18e is performed by using the corrected driving signal COM (a printing initiating process S20). In other words, by ejecting ink using the corresponding corrected driving signal COM, the ink ejection timing is corrected to offset the deviation in the impact positions caused by the temperature change. By doing so, even though the environmental temperature where the printer 1 is used changes from the reference temperature, the deviation in the impact positions of the ink ejected from each recording head 18a to 18e to the recording medium is suppressed as quickly as possible. As a result, the deterioration in the image quality of the recorded image caused by the temperature change is prevented. In addition, in the case where a temperature correction table corresponding to 25° C. is selected, the correction count values of L1 to L4 are all 0. In this case, since timing correction is performed to the driving signal COM so that the deviation in ink impact positions of each recording head 18 at the reference temperature is suppressed in the timing compensating process S13, a desirable printing result may be obtained even though the timing correction is not performed.

In addition, since the temperature correction table is made based on the relative position changing rate obtained from actual measurement results from each recording head 18a to 18e in the relative position changing rate obtaining process, the gap of the relative position change with respect to the temperature change for each recording head 18 may be reflected on the timing correction. By doing so, the deviation in the impact positions is more reliably suppressed. In addition, since the relative position changing rate obtained in the relative position changing rate obtaining process is converted into two-dimensional codes and adhered to the head unit 17 as the shared QR label 60, for example, when each recording head 18 of the head unit 17 is repaired or replaced, the relative position changing rate may be reflected on the adjustment by reading the corresponding shared QR label 60. In addition, since the relative position changing rate is obtained in a state where the head unit 17 is configured, a down time (non-operation time) decreases in comparison to the case where the relative position changing rate is obtained from a final product when the head unit 17 is replaced or maintained due to failure, and thus the operation rate of a final product may be improved.

In addition, even though this embodiment illustrates the case where the temperature correction table is made based on an actually measured relative position changing rate, the invention is not limited thereto. For example, the tendency of relative position change of each recording head 18 with respect to the temperature change may be obtained in advance through experimentation or the like without performing the relative position changing rate obtaining process, so that the temperature correction table is made based on this tendency. By doing so, the relative position changing rate obtaining process may be unnecessary, and the production becomes easy.

In addition, the invention is not limited to each embodiment above, but may be modified in various ways based on the appended claims.

Even though the above embodiment illustrates the configuration of creating the temperature correction table based only on the relative position changing rate of the recording heads 18a to 18e caused by the temperature change, the invention is not limited thereto. For example, it may also be conceived that the nozzle forming surface 53 of each recording head 18 inclines according to the temperature change with respect to the recording medium (or, the platen 19). By doing so, a deviation may occur in ink impact positions. In this consideration, the inclination of the nozzle forming surface 53 caused by the temperature change may be reflected on the temperature correction table. In this case, during the head unit manufacturing process, a process of obtaining an impact position changing rate based on the inclination of the nozzle forming surface 53 (an impact position changing rate obtaining process) is performed in addition to the relative position changing rate obtaining process.

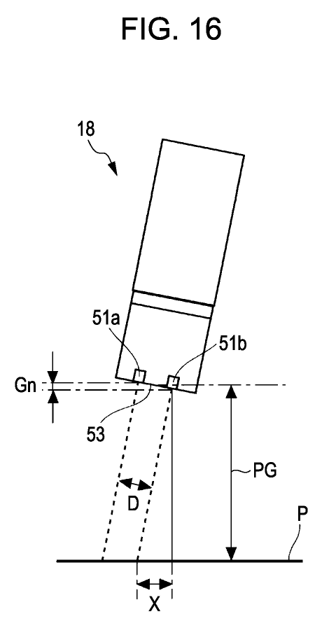

FIG. 16 is a schematic diagram for illustrating the impact position changing rate obtaining process. In FIG. 16, for convenience, only one of the recording heads 18 is depicted. In this embodiment, first, in a nozzle row 51 in one side (in this embodiment, the left nozzle row 51 in FIG. 16) of each recording head 18a to 18e is indicated by 51a, and the nozzle row 51 at the other side is indicated by 51b. In addition, based on the recording paper P (or the platen 19), the difference Gn in heights between the nozzle row 51a and the nozzle row 51b with respect to each recording head 18 is measured. In addition, the state where the nozzle row 51a is at a higher position than the nozzle row 51b is set to be negative (−), and the state where the nozzle row 51a is at the lower position than the nozzle row 51b is set to be positive (+). Even in this process, similar to the relative position changing rate obtaining process, the reference temperature is 25° C., and the difference Gn in height of the nozzle rows when being set to 10° C., 25° C., and 40° C. is respectively measured. Of course, the reference temperature, the set temperature value, and the set temperature number may be changed as desired. Next, based on the measured height difference Gn of the nozzle rows and the ratio between the distance D between the nozzle row 51a and the nozzle row 51b and the distance PG from the nozzle 45 to the recording paper P (or the platen 19), a deviation amount X between the impact position in the state where an inclination does not occur and the impact position in the state where an inclination occurs is calculated. Even in this embodiment, the first recording head 18a becomes the reference head, and a deviation amount when the deviation amount for the first recording head 18a is a reference (0) is acquired. Since the deviation amount X of the impact position is generally proportional to the temperature, the inclination γ (mm/° C.) is derived by linearly approximating the measurement results at each set temperature, so that the corresponding inclination γ becomes the impact position changing rate. In other words, in the impact position changing rate obtaining process, impact position changing rates (inclinations γ1 to γ4) for temperature are respectively obtained with respect to the second to fifth recording head 18b to 18e.

The impact position changing rate obtained in the impact position changing rate obtaining process is converted into two-dimensional codes together with the relative position changing rate, and it is adhered to the label adhesion portion 27 of the sub-carriage 26 as the shared QR label 60 common to each recording head 18 and simultaneously read in the QR label information reading process and stored in the storage unit 65. In addition, in the temperature correction table creating process, the impact position deviation amount (=γT−δ (δ: an integer to make the amount be 0 in the case of the reference temperature)) at each temperature when the case of the reference temperature becomes 0, from the impact position changing rate, namely the inclinations γ1 to γ4, is acquired. In addition, the obtained value is added to the declination of L1 to L4 demanded from the relative position changing rate. By doing so, the deviation in the impact positions caused by the inclination of the nozzle forming surface 53 when the temperature changes may be reflected on the temperature correction table, and the deviation in ink impact position may be more reliably suppressed.

In addition, even though the above description is based on the ink jet printer 1 which is a kind of the liquid ejecting apparatus, the invention may also be applied to another liquid ejecting apparatus in which a plurality of liquid ejecting heads are fixed is fixed to the head fixing member to configure the head unit. For example, the invention may be applied to a display manufacturing apparatus for manufacturing color filters such as a liquid crystal display, an electrode manufacturing apparatus for forming an electrode of an organic EL (Electro Luminescence) display or a FED (Field Emission Display), a chip manufacturing apparatus for manufacturing a biochip (a biochemical element), and a micro-pipette for accurately supplying a very small amount of specimen solution.

What is claimed is:

1. A liquid ejecting apparatus, comprising:
a head unit that includes a liquid ejecting head, which has a nozzle forming surface where a nozzle row having a plurality of nozzles installed in a direction crossing a head movement direction is formed and drives a pressure generating unit to eject liquid from the nozzles so as to impact an impact target, and a head fixing member to which a plurality of the liquid ejecting heads are arranged and fixed;
a moving unit that relatively moves the corresponding head unit and the impact target in a head installation direction;
a temperature detecting unit that detects an environmental temperature in the liquid ejecting apparatus;
a storage unit that stores control information associated with the control of liquid ejection; and
a control unit that controls liquid ejection of each liquid ejecting head,
wherein the storage unit stores a temperature correction table where the temperature detected by the temperature detecting unit is associated with correction information of liquid ejection timing, and
wherein the control unit corrects the liquid ejection timing of each liquid ejecting head with reference to the temperature detected by the temperature detecting unit and the temperature correction table.

2. The liquid ejecting apparatus according to claim 1,
wherein any one of the liquid ejecting heads fixed to the head fixing member is a reference head, and
wherein the correction information is information about correction for the difference in liquid impact positions on the impact target caused by a change in relative position of each liquid ejecting head with respect to the reference head in the head installation direction, accompanied by the temperature change from a predetermined reference temperature.

3. The liquid ejecting apparatus according to claim 2, wherein the correction information is determined based on a rate of change of the relative position of each liquid ejecting head with respect to the reference head in the head installation direction, accompanied by the temperature change.

4. The liquid ejecting apparatus according to claim 3, wherein the head unit includes a head information recording portion where the relative position changing rate is recorded.

5. The liquid ejecting apparatus according to claim 4,
wherein the head information recording portion stores a changing rate of the liquid impact position in the head installation direction by an inclination of the nozzle forming surface, accompanied by the temperature change from the reference temperature, in addition to the changing rate of the relative position, and
wherein the correction information is determined based on the changing rate of the relative position and the changing rate of the impact position.

6. The liquid ejecting apparatus according to claim 4, wherein the head information recording portion is a two-dimensional code.

7. A method for manufacturing a liquid ejecting apparatus including a head unit that includes a liquid ejecting head, which has a nozzle forming surface where a nozzle row having a plurality of nozzles installed in a direction crossing a head movement direction is formed and drives a pressure generating unit to eject liquid from the nozzles so as to impact an impact target, and a head fixing member to which a plurality of the liquid ejecting heads are arranged and fixed; a moving unit that relatively moves the corresponding head unit and the impact target in a head installation direction; a temperature detecting unit that detects an environmental temperature in the liquid ejecting apparatus; a storage unit that stores control information associated with the control of liquid ejection; and a control unit that controls liquid ejection of each liquid ejecting head, the method comprising:
positioning and fixing each liquid ejecting head to the head fixing member to configure the head unit;
setting any one of the liquid ejecting heads as a reference head and obtaining a changing rate of a relative position of each liquid ejecting head with respect to the reference head in the head installation direction, accompanied by the temperature change from a predetermined reference temperature;
recording each relative position changing rate obtained in the setting in a head information recording portion, and endowing the head information recording portion to the head unit;
assembling the head unit with the liquid ejecting apparatus;
creating a temperature correction table where the temperature detected by the temperature detecting unit and the correction information of liquid ejection timing are associated, based on the relative position changing rate recorded in the head information recording portion; and
storing the temperature correction table in the storage unit.
